(19) United States
(12) Patent Application Publication
(10) Pub. No.: US 2011/0163032 A1
(43) Pub. Date: Jul. 7, 2011

(54) HIGH RECOVERY SULFATE REMOVAL PROCESS

(75) Inventors: Gerald Alexander, La Canada, CA (US); Stanley R Karrs, Gibsonia, PA (US); Richard Woodling, Singapore (SG); Karthikeyan Sathrugnan, Singapore (SG)

(73) Assignee: Siemens Pte Ltd, Singapore (SG)

(21) Appl. No.: 13/119,275

(22) PCT Filed: Sep. 17, 2009
(86) PCT No.: PCT/US09/57276

§ 371 Date: Mar. 16, 2011

(51) Int. Cl. C02F 1/44; C02F 1/52

(52) U.S. Cl. 210/638; 210/639

(57) ABSTRACT

A high recovery sulfate removal process comprises treating a feed water stream conditioned with antiscalant from a source with a reverse osmosis membrane system to produce a purified water permeate stream and a reject stream containing the retained or rejected ions and organic matter. The reject stream is further treated to remove dissolved and suspended species. The reject stream flows to a desaturation/clarification process. A preferred process includes a constant stirred tank reactor (CSTR) where co-precipitation agent is added followed by a clarifier. Water recycled from the clarifier overflow is blended with feed water stream. The removed solids are collected as sludge or a slurry and disposed of in a manner consistent with applicable regulations.

### FIELD OF THE INVENTION

This invention relates to a process for sulfate removal from a water source, and more particularly, to a high recovery process which utilizes reverse osmosis for sulfate removal from a water source.

### BACKGROUND OF THE INVENTION

High concentrations of sulfates in water sources present problems to wetlands and their wildlife inhabitants. An example of great concern is the high level of sulfates entering the Everglades, which is reported to be 60 to 100 times normal background. Sulfates can stimulate microbial sulfate reduction (MSR) wherein sulfate reducing bacteria (SRB) produce sulfide from sulfate in the course of degrading inorganic matter and which controls the methylation and bioaccumulation of neurotoxic methyl mercury (MeHg) in the Everglades. MeHg is a potent neurotoxin that bioaccumulates in fish and other wildlife. Other deleterious effects of high levels of sulfates are the generation of hydrogen sulfide and the accelerated release of nitrogen and phosphorous from soils, termed autoeutrophication.

Acid mine drainage (AMD), sometimes referred to as Acid Rock Drainage, represents a large source of sulfate containing waters. Acid mine drainage (AMD) is low pH water arising from oxidation of iron and other sulfides to sulfuric acid. It is usually considered as water that flows from coal mines or mining waste or tailings, but can occur in metal mining, highway construction and other deep excavations. AMD is a common term sometimes used to refer to any mine operation discharge, many of which are alkaline.

The traditional treatment of AMD is with lime and limestone to neutralize acidity and precipitate out calcium sulfate (gypsum). However, relatively high levels of sulfate remain. Depending on composition and ionic strength, sulfate concentrations of about 1500 mg/l to up to 4000 mg/l, may remain after such treatments. Calcium content is also high due to the lime treatment, and there are other metal ions present as well.

A review of sulfate treatment processes are described in Chapter 3 of “Treatment of Sulphate in Mine Effluents”, October 2003, a final report from International Network for Acid Prevention (INAP) Salt Lake City, Utah 84109 USA. Chemical, membrane ion exchange and biological mechanisms are described. The report can be found at http://www.inap.com.au/public downloads/Research Projects/Treatment of Sulphate in Mine Effluents—Lorax Report.pdf

Cost effective methods and apparatus are sought to reduce effluent concentrations of sulfate to below 500 mg/l, and more preferably below 250 mg/l. A useful guideline is that the EPA Secondary Drinking Water Regulations recommend a maximum concentration of 250 mg/l for sulfate ions. Many of the water sources generating AMD are located at remote sites, requiring compact and low energy usage systems. Furthermore, waste disposal has to be controlled to prevent despoiling natural resources.

Other metal ions in AMD may also require remediation or removal. Molybdenum can concentrate in forage and be toxic to ruminant animals. Molybdenum is very toxic to trout eggs. While not considered a US EPA priority pollutant, a US water equivalent level of 0.2 mg/liter is given. The World Health Organization suggests a guideline value of 0.07 mg/liter for drinking water.

Many trace metals including molybdenum do not precipitate as metal hydroxides. Iron hydroxides will remove molybdenum by co-precipitation through attachment to the iron floc surface.

High recovery reverse osmosis processes have been reported previously. U.S. Pat. No. 5,501,798 describes a process that adds antiscaling agents to an RO feed. The RO membrane process of U.S. Pat. No. 5,501,798 separates soluble and sparingly soluble inorganic materials into a reject and a purified permeate stream. The reject stream is treated to precipitate solid particles which are filtered by a microporous or ultrafiltration cartridge filter. The filtered water is returned to the RO feed stream.

U.S. Pat. No. 6,461,514 describes a RO process wherein water is pretreated to remove all suspended solids, oil and grease, iron, etc. The pretreated stream is blended with a softened high total dissolved solids (TDS) water stream and acid and antiscalant added prior to being fed to a single stage RO system. The RO system separates the feed into a purified permeate stream and a concentrated ion containing reject stream. The concentrate passes through an ion exchange softener which removes hardness ions and produces a high TDS stream which is blended with the pretreated water stream. From 0.1% to 5% of the reject stream is removed to drain to control osmotic pressure in the RO process.

APS (accelerated precipitation softening) demineralization, is a method described in Journal of Membrane Science Journal of Membrane Science (2007) V 289 pp 123-137. APS is used between a primary and a secondary RO system, and involved alkaline pH adjustment and calcite crystal seeding of the primary RO concentrate, followed by microfiltration and pH reduction by acid dosing to avoid calcite scaling in the SRO stage. This method requires multiple RO systems, increasing costs and complexity and was used for mildly brackish water and not for the high mineral containing waters of AMD.

Processes for sulfate removal must handle high concentrations of sulfate and calcium ions which are prone to fouling or scaling process equipment. Microporous or ultrafiltration membranes are high cost processes and would be prone to excessive fouling and loss of process capability with high solids content precipitates. Likewise, ion exchange softeners are high cost processes for processing low value feeds such as acid mine drainage and would be ineffective due to the low pH of the feed. An article in Ultrapure Water (Volume 29#9 September 2009) estimates sulfate removal by ion exchange at $9-$18/1000 gallons (3.8 cubic meters. The goal cost in 2009 for AMD sulfate removal is approximately $1/cubic meter (˜$4/1000 gallons).

Sulfate removal from AMD often occurs in remote and rugged locations. Any process for sulfate removal should be robust and simple in order to operate in such conditions. The process described herein uses a reverse osmosis system combined with standard chemical process steps to from a novel process for sulfate removal from water, particularly from acid mine drainage, at high recovery. High recovery is important to minimize the volume of reject streams containing concentrated minerals that have to be disposed and to maximize the amount of purified water produced per unit of source water processed.

### SUMMARY OF THE INVENTION

The invention is directed to a high recovery process and system to remove sulfate, calcium and other ions from water sources. The process utilizes a high pressure reverse osmosis (RO) system to retain the calcium, sulfate and other trace ionic contaminants and organic matter and produce a purified water stream. The reverse osmosis concentrate containing retained ionic and organic matter is treated to remove ions and organic matter and the treated water is returned to the feed of the RO unit. Several methods of treating the RO concentrate are described herein. A preferred method is coagulation and precipitation of ionic and organic species and matter. A more preferred method is precipitation of ionic and organic species and matter wherein more than one precipitating agent is used. The term “co-precipitation” refers to the precipitation of the agent or agents, such as ferric hydroxide from the hydrolysis of ferric chloride, or gypsum seeds and the desired precipitation of the minerals and organic matter caused by the addition of the agent.

### BRIEF DESCRIPTION OF THE DRAWINGS

FIG. 1 illustrates a high recovery sulfate removal process in accordance with the present invention.

FIG. 2 depicts schematic diagram of the process flow process employed in a study in accordance with the present invention.

### DETAILED DESCRIPTION OF THE INVENTION

The high recovery sulfate removal process comprises treating a feed water stream from a source with a reverse osmosis membrane system to produce a purified water permeate stream and a reject stream containing the retained or rejected ions and organic matter. The reject stream is further treated to remove dissolved and suspended species. Water from the reject stream after treatment is blended with feed water stream. The removed solids are collected as, sludge or a slurry and disposed of in a manner consistent with applicable regulations.

An object of the process described herein is to operate at high recovery. Recovery is defined as the ratio of the flow of permeate to the flow rate of the incoming feed stream.

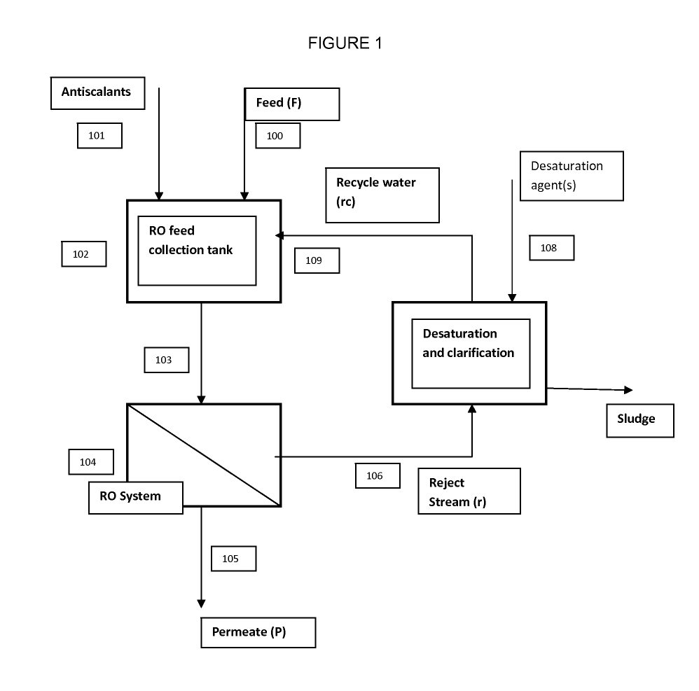

FIG. 1 illustrates a simplified view of the process. Water from a source enters a feed collection tank (100) at a flow rate of F where it is blended with antiscalant which is of small volume and not considered in the discussion below, and r_{c}, the clarified flow (107) from the desaturation step. The components are blended, either by flow or with a mixing or stirring apparatus.

The combined flow is sent to the RO system through line 103 at a flow of f. The RO system separates the flow into a purified permeate stream of flow rate P, and a reject stream with the concentrated ions and organic matter which has a flow rate r (106). The reject stream flows to desaturation/clarification tank (107), which may one or two separate tanks, but is usually a constant stirred tank reactor (CSTR) followed by a clarifier. One or more coagulation agents (108) are added to the desaturation tank, usually with stirring and the allowed to react for an average residence time to develop floc size and density.

The clarifier may be a cylindrical tank with a conical bottom and a bottom outlet. Precipitated solids or sludge settles to the bottom and is removed as required. Clarified water overflows a weir or outlet line. The clarified water flow r_{c} (109) is combined with water feed F at a ratio=F/r_{c}. A preferred range of for F/r_{c} is 90/10 to 70/30, a more preferred range is 85/15 to 75/25.

The recycle water to be blended must be suitable for blending. This means that the recycle water must not contain mineral or organic material at a concentration so high that the blended water deleteriously affects the RO process. Preferably, materials in the recycle water stream prone to cause fouling reduced to approximately the same concentration or lower than the pretreated source water.

Descriptive Example of Recovery

The overall process recovery Rₒ is Rₒ=P/F, where P=permeate flow rate.

The recovery of the reverse osmosis step Rᵣₒ=P/f, and, f=F+r_{c}

For illustration, the ratio F/r_{c} is taken as 70/30, 80/20, and 90/10. This results in Rₒ=1.46 Rᵣₒ, 1.25 Rᵣₒ and 1.11 Rᵣₒ respectively.

This simple example shows how a practitioner would control overall recovery, which is of main concern, by varying reverse osmosis system recovery and the F/r_{c} ratio. Illustrative calculations are given in the table below.

| Rᵣₒ | Rₒ@70/30 | Rₒ@80/20 | Rₒ@90/10 |
|---|---|---|---|
| 50 | 71.4 | 62.5 | 55.5 |
| 60 | 87.6 | 75 | 66.6 |
| 70 | ~100 | 87.5 | 77.7 |

Water to be treated is usually held in a lagoon, pond, storage tank or similar facility. Before entering the treatment process train, a pretreatment step commonly used to protect the RO system by removing particles, organic matter, bacteria, and other contaminants. Prefiltration is a preferred method. Slow sand filtration may be used. A more preferred method is dual media sand filtration. This method uses a layer of anthracite over a layer of fine sand. Other methods may be used singularly or in combination. These include, but are not limited to, mixed media filtration and non-woven fabric or other cartridge filtration.

Reverse osmosis membrane modules can be supplied in a variety of properties. So-called seawater membranes are used to desalinate seawater (equivalent to approximately 35,000 ppm NaCl) at pressure of 800-1500 psi. This type of membrane will retain over 99% of incident salt. So-called brackish water membranes operate at lower pressures in waters of lower ionic strength. They will have relatively lower inherent retention of salt ions, but have a higher permeability and when properly engineered, will operate economically. Nanofiltration (NF) membranes are so-called “loose” reverse osmosis membranes which retain multivalent ions and species of greater than about 400 molecular weight. NF generally pass a high percentage of monovalent ions. They have relatively higher permeability than the previously described membranes.

In a RO process, a continuous flow of feed water contacts across one side of the RO membrane at an elevated pressure. The pressure is above the osmotic pressure of the feed water, generally multiples of the osmotic pressure. Purified water passes through the membrane to the low pressure side of the process as permeate. The retained salts and organic matter removed from the feed water are concentrated in the remaining water, that is, the water that does not exit as permeate. This is the reject stream, which flows to be processed or disposed of, depending on the use of the RO process.

The purpose of the RO process step is to concentrate sulfate, calcium, other divalent metals and organic matter while passing purified water to downstream fate. Recovery is defined for water flow as the permeate flow to the concentrate flow. For economy and ease of operation, the RO membranes may be chosen to retain a high proportion of divalent cations and sulfate, and to pass some of the monovalent ions with the permeate water stream. The overall RO step can be engineered in a variety of conformations, depending on the amount of water to be processed, the feed concentrations and the required output. Reverse osmosis system design is the topic of several books, such as The Guidebook to Membrane Desalination Technology: Reverse Osmosis, Nanofiltration and Hybrid Systems Process, Design, Applications and Economics (Wilf, M., et al; Desalination Publications).

While practitioners commonly may use once through flow in reverse osmosis operations, practitioners also use concentrate recirculation, where the concentrate is returned to the feed storage tank. In relatively small applications, such as waste water, where intermittent or non-continuous discharge is used, a batch or semi-batch method is common. A batch operation is one in which the feed is collected and stored in a tank or other reservoir, and periodically treated. In semi-batch mode, the feed tank is refilled with the feed stream during operation.

The RO system may have single or multiple stages. In a single stage system, the feed passed through one or more pressure vessel arrange in parallel. Each pressure vessel will have one or more membrane modules in series. The number of stages is defined as the number of single stages the feed passes through before exiting the system. Permeate staged systems use permeate from the first stage as feed for the second stage, and if multiple stages are used, permeate from a stage just prior is used as feed for the following stage. In as reject staged system, the reject stream of a stage is sent to become the feed stream of a subsequent, usually the next, stage. Reject, concentrate and retentate and similar terms have synonymous meanings in RO processing

To operate the process at high recoveries, practitioners use chemicals termed anti-scalants to prevent precipitation of ions of marginal solubility. Common anti-scalants are proprietary mixtures commonly containing polycarboxylic acids, polyacrylic acid and phosphino carboxylic acid polymers. Optimal molecular weights have been reported in the range of 1,000-3,500. Other polyelectrolytes sometimes used are polyphosphonates and polyphosphates. These chemicals prevent precipitation of calcium and other salts at the membrane surface as the feed is concentrated at the high pressure side of the reverse osmosis membrane, thereby maintaining permeate productivity. However, the presence of anti-scalants in the desaturation tank will reduce the effectiveness of metal removal by desaturation. Therefore, a balance is required between reducing fouling in the RO step and increasing or maintaining desaturation efficiency.

When adding antiscalants, it is common practice to add acid or base as needed to optimize the pH of the water being treated. The antiscalant addition and pH adjustment is termed conditioning.

A preferred antiscalant is PC504T (Nalco Company 1601 W. Diehl Road Naperville, Ill. 60563-1198 U.S.A.) Concentrations of higher than generally recommended for brackish water are preferred with a preferred concentration being approximately 17 mg/liter. It is critical that fresh solutions of antiscalant be used.

The preferred treatment method for the reject stream is precipitation or co-precipitation and settling followed by clarification. Precipitation is also termed sedimentation, desaturation, or thickening. Clarification refers to the water above the settling or settled precipitate which is clearer—having less dissolved and suspended matter—that the reject stream sent to the precipitation tank.

A more preferred treatment method comprises using more than one coagulant to foster co-precipitation or co-coagulation. Co-precipitation refers to the precipitation of the agent, for example ferric chloride after being hydrolyzed upon addition to the desaturation tank and the concurrent precipitation of the small particles and colloids in the desaturation tank. In a most preferred method, two or more agents which foster precipitation are added to the reject stream in order to obtain more effective precipitation and removal of dissolved and suspended species.

Preferred coagulants include ferric sulfate, ferrous chloride and aluminum sulfate. More preferred coagulants are ferric chloride and gypsum precipitate. A most preferred coagulant is a blend of ferric chloride and precipitated gypsum.

Ferric chloride is hydrolyzed in alkaline water to form several products which incorporate Fe(OH)₃ having high cationic charge density. This allows for neutralization of charge of colloidal compounds, negatively charged particles and also self aggregation. In this way floc aggregates are formed which remove small metal precipitates. Ferric chloride flocs form more discrete and dense flocs, giving better sedimentation. In addition, ferric chloride flocs are known to remove organic matter (TOC). This is particularly important where the reject stream is returned to the feed side of the RO membrane system and continuously increasing TOC (total oxidizable carbon) content would deleteriously affect the membranes and reduce permeation.

Added ferric chloride concentrations of 10 mg/liter to 400 mg/liter are a preferred range. Lower concentrations have proven useful, in the concentration range of 10-200 mg/liter, even to 10-25 mg/liter. Since each AMD feed will be different, the practitioner will use these ranges to find an optimum range for their particular case.

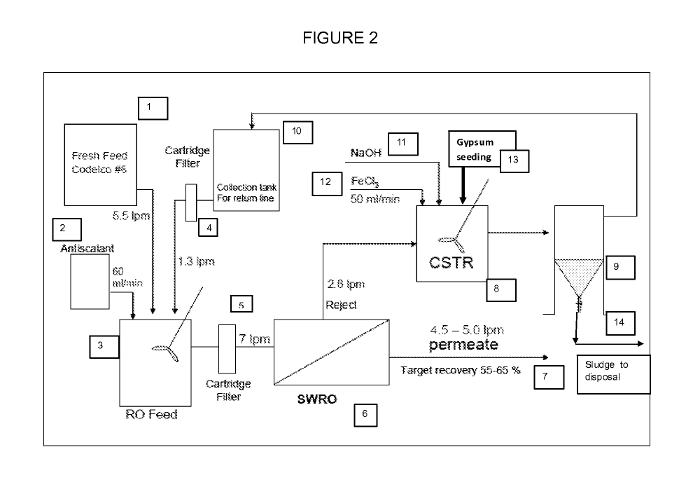

Seeding the reject with gypsum precipitate is also a preferred method of co-precipitating the reject stream. Fresh gypsum particles or seeds are highly preferred. These are taken from the sludge stream and added to the CSTR (8 in FIG. 2). The amount to be added will depend on how the reject stream responds to the seeding, but a starting point is 25 to 50 grams of gypsum seeds/liter. In a continuous operation, a portion of the sludge is continuously removed and fed to the CSTR to serve as co-precipitate. Complete changeover of sludge in order to obtain fresh seeds is necessary on a regular schedule, usually the equivalent of 3-5 CSTR cycles.

A more preferred method is the combination of gypsum seeding and ferric chloride. In this method, a preferred range for ferric chloride addition is in the range of 10-25 mg/liter.

The range of pH of 3-6 has been found to be satisfactory for co-precipitation in the process.

Gypsum precipitation is best done at the maximum sulfate concentration possible. This requires that the RO stages be optimized to obtain the maximum level of sulfate possible consistent with proper operation of the RO system. Seeding the reaction solution with gypsum particles is a preferred method to obtain higher removal efficiency. Seed concentration added to aid precipitation will vary depending on conditions such as sulfate concentration, time required by other process scheduling requirements and other conditions. Preferred seed concentrations are between about 0.4% to about 3%.

High concentrations of monovalent cations such as sodium reduce desaturation of calcium and other multivalent ions through the well-known common ion effect where the increased ionic strength of the solution changes the activity portion of the solubility product. A skilled practitioner will operate the RO process to pass as high an amount of monovalent cations as can meet relevant downstream requirements and regulations while retaining substantially all multivalent ions.

Depending on the requirements for the permeate stream, practitioners may choose to operate the RO system in a manner so as to allow sodium passage and reduce sodium content in the reject stream.

In the case where a CSTR is used to mix and react the coagulating agents with the incoming reject stream, there is a reaction time during which coagulated particles form and increase in size. Each feed and coagulating system will have different optimal or useful average reaction times. Average time is defined as the volume of the liquid in the CSTR divided by the flow rate of the reject stream flowing on and out of the CSTR. In a batch system or if the CSTR is used in a batch mode, the reaction time would be the time between initial co-precipitation agent addition and emptying of the tank.

In the process being described, multiple cycles of gypsum seeding are used. In the method, a portion of the settled solids from the bottom of the clarifier are sent to the CSTR to act as co-precipitating agent. It has been shown that the effectiveness of the gypsum decreases after several cycles. A cycle can be defined as a factor, which can be greater than one, times the average reaction time. To prevent serious loss of effectiveness, the settled materials in the clarifier bottoms should be disposed of and fresh gypsum seeds accumulated. Each feed water/process combination will have different responses in terms of the number of effective cycles, which will have to be determined empirically. The number of effective cycles can be determined by a skilled practitioner without undue experimentation using the examples described in the Experimental section.

The precipitated matter process stream is formed by gravity settling. Gravitational settling is a simple method of sludge removal. Settling rate may be increased by using flocculating agents. Cationic, anionic or non-ionic flocculants may be used. Acrylamide polymers, polyaminoacrylate polymers and sulphonated polystyrene are among the types of flocculants typically used. However, care must be taken to assure these agents do not accumulate excessively in the clarifier overflow being returned to the RO feed, as these polymers may cause fouling.

Filtration may also be used to dewater and concentrate the sludge. This would be effective, for example, in cases where the precipitated solids have commercial value, or where there is limited solids holding space. Standard methods of filtration, such as leaf filtration, rotary drum filtration, rotary disk filtration, horizontal belt or horizontal table filtration. These and other methods are described in standard texts, for example; Perry's Handbook 7^{th} Edition (McGraw-Hill NY).

Organic matter removal is an important feature of the process. This is referred to as TOC (total oxidizable carbon) removal, relating to the analytical method used to measure organic matter in water. If TOC concentrated in the reject stream were to remain through the precipitation and clarification steps, it would continuously increase in the RO feed and eventual foul the membrane. It is preferred that the precipitation step remove TOC to about the level of the raw feed water so that TOC does not increase.

Molybdenum (Mo) removal in the co-precipitation step is important because this concentrates Mo in the sludge for disposal. Without removal in the co-precipitation step as operated, a additional removal scheme would be required to produce a solid Mo waste, increasing costs and process complexity.

### EXPERIMENTAL

### 1. Introduction

Acid Mine Drainage, (AMD) that has been lime treated, still contains a high amount of calcium (˜1130 mg l−1). sulfate (˜2600 mg l−1). The residual sulfate requires treatment prior to discharge in order to meet local environmental regulations. The desired lifecycle cost per cubic meter of treated water is 1 US dollar.

### 2. Process Description

The process will consist first of TSS removal and pH adjustment. The optimum pH will be determined by the specific feed however it is anticipated to be in the 4-6 standard pH units. Next, an antiscalant such as Nalco PC504T is added to the stream. Following pretreatment, the stream is processed with a reverse osmosis unit designed according to TDS and recycle of precipitate mother liquor. It is anticipated to be a high pressure RO (600-1000 psi). The permeate of the RO is collected and reused or discharged. The concentrate, which is supersaturated in Calcium Sulfate is sent to a stirred tank reactor where 100 ppm of iron (III) chloride is added. The pH is simultaneously adjusted to counteract the acidification caused by the addition of the Iron (III) Chloride. The Iron (III) Chloride is hydrolyzed to Iron (III) hydroxide which has a very limited solubility in water and precipitates. During the precipitation of Iron(III) Hydroxide, more correctly termed Iron (III) oxide-hydroxide monohydrate, desaturation of the Calcium sulfate by precipitation/co-precipitation/seeding occurs. Other metals such as molybdenum are also precipitated via the co-precipitation mechanism. The process is illustrated in FIG. 1.

### 3. Laboratory Experiments

A series of jar test experiments were conducted to validate the Iron (III) co-precipitation for gypsum desaturation and removal of other trace contaminants including Molybdenum from the RO reject. Alternative reagents were also investigated to determine their efficacy in gypsum desaturation and removal of trace contaminants.

### 3.1 Effect of Fe Concentration in Gypsum Desaturation

A simulated synthetic waste was prepared to replicate anticipated RO reject at 75% recovery. Antiscalant dosage of 40 mg/l was added to the synthetic waste which is what the concentration would be in the RO concentrate assuming no loss of antiscalant via the RO membrane and a 10 mg/l feed prior to the RO The synthetic reject contained 4,000 mg/l of Ca and 10,000 mg/l of sulfate and other trace elements as will be described.

In the first experiment, 200 ml of synthetic RO reject was dosed with different amounts of Fe as FeCl₃ under fast stirring (˜200 rpm) conditions. The pH of the mixture was adjusted to 4.5 standard units using 10% NaOH solution. The mixture was stirred for 15 minutes and then allowed to settle. The supernatant solution was filtered through a 0.45 micron Whatman membrane filter and analyzed for Calcium, sulfate and other trace contaminants. The results given in Table 1 show that 100 mg/l Fe dosage could desaturate 66-70% of gypsum and further could reduce many trace contaminants as well. However, magnesium was not observed to be reduced in concentration.

TABLE 1
Gypsum desaturation by Fe co-precipitation

| Fe | Ca | SO4 | Al | B | Ba | Cu | Fe | Mn | Mg | Mo | Zn |
|---|---|---|---|---|---|---|---|---|---|---|---|
| 0 | 3927 | 9000 | 7.025 | 0.21 | 0.21 | 2.70 | 0.03 | 0.15 | 101.0 | 12.0 | 0.039 |
| 100 | 1138 | 3000 | 0.12 | 0.03 | 0.05 | 0.64 | 0.18 | 0.04 | 100.7 | 0.02 | 0.06 |
| 200 | 1359 | 3600 | 0.01 | 0.01 | 0.01 | 0.12 | 0.10 | 0.02 | 97.5 | 0.02 | 0.03 |
| 400 | 1321 | 3400 | 0.06 | 0.03 | 0.02 | 0.45 | 0.53 | 0.05 | 96.1 | 0.01 | 0.04 |

Concentrations are in mg/l

3.1.1 Desaturation of Actual RO reject using Fe

A series of small batch operations with AMD feed was processed via an RO utilizing 10 mg/L of Nalco PC504T antiscalant. During the operation, the RO was observed to have a rapid and continuous flux declination. Antiscalant software projections suggested that ‘Aluminum’ was poisoning antiscalant and also reached super saturation. Upon precipitation of the Al, complete gypsum desaturation occurred if Ca level exceeded 2,000 mg/l in the RO reject. It was also seen that phosphate was also very high and could be the next challenge. Nalco recommended antiscalant dosage of 17 mg/L was required to prevent scaling. Perhaps the most surprising aspect after several repetitions of this experiment was that the moment an ion precipitated, even in small amounts such as in the case of Al, (8 ppm in reject stream), complete failure of the antiscalant was observed leading to decrease in membrane permeation. This led to further experiments as described in section 3.2.

Next, a batch of synthetic feed containing all components except aluminum was prepared using 17 mg/l (as product) of antiscalant. The material was processed with the RO at 75% recovery. Complete processing occurred without precipitation. The concentrate was then desaturated using Fe co-precipitation methodology with results similar to previous synthetic concentrate experiment. Specifically, 200 ml of RO reject was dosed with 100 mg Fe/l and the pH of the mixture was adjusted to 4.5 standard units using 10% NaOH.

Stirring was continued for 15 min followed by a period of time to allow settling. The supernatant liquid was filtered and analyzed for calcium and other trace contaminants.

The results are presented in Table 2. The results are similar to that previously obtained for synthetic Reject. Gypsum desaturation was about 70%.

TABLE 2
Gypsum desaturation of RO reject by Fe co-precipitation

| Sample | Ca | SO4 | Al | B | Ba | Cu | Fe | Mn | Mg | Mo | Zn |
|---|---|---|---|---|---|---|---|---|---|---|---|
| RO Reject | 4082 | 8400 | 0.10 | 0.36 | 0.12 | 0.99 | 0.05 | 0.28 | 80.6 | 0.48 | 0.52 |
| Desaturation | | | | | | | | | | | |
| samples | | | | | | | | | | | |
| 1 | 1181 | 3176 | 0.1 | 0.43 | 0.15 | 1.2 | 0.78 | 0.47 | 74.3 | 0.18 | ND |
| 2 | 1262 | 3059 | 0.1 | 0.43 | 0.12 | 1.1 | 0.65 | 0.50 | 74.6 | 0.15 | ND |
| 3 | 1244 | 3000 | 0.1 | 0.42 | 0.15 | 1.0 | 0.52 | 0.46 | 74.4 | 0.15 | ND |

Concentrations are in mg/l
* Sample 1, 2 & 3 are replicates

Another batch of feed solution containing a small amount of Aluminum (0.3 mg/l) was prepared and processed through the RO at 45 and 65% recovery. Both these rejects were then processed for desaturation. The results are shown in Table 3 which also suggests that initial ‘Ca’ concentration appears to be one of the limiting factors in gypsum desaturation with Fe co-precipitation. The lower the initial concentration, the poorer the desaturation efficiency.

TABLE 3
Gypsum desaturation of RO reject by Fe co-precipitation

| Sample | Ca | Al | B | Ba | Cu | Fe | Mn | Mg | Mo | Ni | Zn |
|---|---|---|---|---|---|---|---|---|---|---|---|
| RO Reject | 1962 | 0.791 | 0.333 | 0.137 | 0.774 | 0.256 | 0.894 | 37.12 | 0.068 | 0.066 | 0.251 |
| @45% | | | | | | | | | | | |
| Recovery | | | | | | | | | | | |
| Desaturation | 1870 | 0.689 | 0.346 | 0.137 | 0.686 | 0.828 | 0.114 | 37.03 | 0.001 | 0.072 | 0.292 |
| RO Reject | 2903 | 1.34 | 0.372 | 0.194 | 1.25 | 0.478 | 0.105 | 54.61 | 0.089 | 0.083 | 0.454 |
| @62% | | | | | | | | | | | |
| Recovery | | | | | | | | | | | |
| Desaturation | 1583 | 1.14 | 0.394 | 0.197 | 1.14 | 2.52 | 0.144 | 52.59 | 0.002 | 0.093 | 0.5 |
| RO Reject | 4082 | 0.068 | 0.363 | 0.121 | 0.999 | 0.051 | 0.277 | 80.55 | 0.285 | 0.477 | 0.52 |
| @70% | | | | | | | | | | | |
| Recovery | | | | | | | | | | | |
| Desaturation | 1181 | 0.109 | 0.433 | 0.155 | 1.28 | 0.781 | 0.473 | 74.31 | ND | 0.183 | ND |

concentration (mg/l)
* pH was adjusted to 4.5

Additional experiments on the effect of pH of iron hydroxide precipitation showed that the pH has slight effect on gypsum desaturation at a given initial ‘Ca’ concentration level. In particular, it was observed that the desaturation was reduced at least by 20% when higher pH was tested. On the other hand, higher pH enhances co-precipitation of other trace contaminants. Therefore, the pH for iron hydroxide should be chosen according to the requirements of the application. The summary of pH effects is presented in Table 4.

TABLE 4
Effect of pH of Fe co-precipitation

| Sample | Ca | SO4 | Al | B | Ba | Cu | Fe | Mn | Mg | Mo | Ni | Zn |
|---|---|---|---|---|---|---|---|---|---|---|---|---|
| RO Reject | 4082 | 8400 | 0.068 | 0.363 | 0.122 | 0.999 | 0.051 | 0.278 | 80.55 | 0.285 | 0.477 | 0.52 |
| @70% | | | | | | | | | | | | |
| Recovery | | | | | | | | | | | | |
| Desaturation | 1181 | 3176 | 0.109 | 0.433 | 0.155 | 1.28 | 0.781 | 0.473 | 74.31 | ND | 0.183 | ND |
| pH 4.5 | | | | | | | | | | | | |
| Desaturation | 1610 | 3200 | 0.23 | 0.37 | 0.06 | 0.05 | ND | 0.24 | 75.1 | 0.02 | 0.04 | ND |
| pH 7.0 | | | | | | | | | | | | |
| RO Reject | 2903 | 4200 | 1.34 | 0.372 | 0.194 | 1.25 | 0.478 | 0.105 | 56.61 | 0.089 | 0.083 | 0.454 |
| @62% | | | | | | | | | | | | |
| Recovery | | | | | | | | | | | | |
| Desaturation | 1586 | 2700 | 0.83 | 0.4 | 0.12 | 1.1 | 1.35 | 0.16 | 52.6 | 0.02 | 0.1 | 0.26 |
| pH 7.0 | | | | | | | | | | | | |
| Desaturation | 1589 | 2600 | 0.42 | 0.39 | 0.11 | 0.34 | 0.74 | 0.11 | 52.1 | 0.02 | 0.1 | 0.22 |
| pH 7.0 | | | | | | | | | | | | |
| Desaturation | 1576 | 2800 | 0.11 | 0.38 | 0.11 | 0.02 | 0.02 | 0.12 | 53 | 0.02 | 0.07 | 0.03 |
| pH 7.0 | | | | | | | | | | | | |

Concentrations are in mg/l

### 3.2 Desaturation Using Other Reagents

Gypsum desaturation was examined by using other reagents which could possibly overcome antiscalant effects. RO reject, 200 ml, was processed for desaturation at pH 7.0 standard unit. Different reagents were added to accelerate desaturation which include Al (10 mg/l); gypsum (50 gpl) and Lime (10 gpl) respectively. The results are shown in Table 5. Gypsum and Aluminum were effective in desaturation. Gypsum seeding was most effective compared to all other reagents; however it was also dosed at highest initial concentration. Lime was kept at 10 grams per Liter to prevent the pH from rising to a high level.

TABLE 5
Desaturation using different reagents

| Reagents | Ca (mg/l) | SO₄(mg/l) |
|---|---|---|
| Initial (RO reject) | 2905 | 4700 |
| Fe (100 mg/l) | 1527 | 2750 |
| Al (10 mg/l) | 1582 | 2850 |
| Gypsum (50 gpl) | 1170 | 2300 |
| Lime (10 gpl) | 3400 | 3500 |

### 3.2.1 Gypsum Seeding

Gypsum generated from desaturation was tested for multiple cycle usage. The gypsum sludge from the initial precipitation was collected as slurry and utilized to re-seed the next batch. The purpose is to reticulate a portion of the sludge to the CSTR to cause desaturation without the addition of other chemicals. This was tested experimentally by first seeding 200 ml of RO reject using fresh CaSO₄ (5 g) and stirring for 30 min. Upon settling, the filtrate was analyzed for Calcium.

The gypsum collected from the previous experiment was used to seed the next cycles of desaturation. The calcium concentration after each desaturation cycle is presented in Table 6. Similar experiments were performed to study the effect of salt concentration and pH for other possible brine applications. Table 6 presents the summary of desaturation by gypsum seeding under various conditions. The results from a multiple seeding cycle precipitations showed that there would be a decrease in desaturation beyond 3-4 cycles.

Gypsum sludge should be discharged at frequent intervals to enable newly generated gypsum for seeding purposes. High salt concentration also reduced desaturation which is mainly caused by the increased gypsum solubility due to the reduction in the activity coefficient (common ion effect). There was no significant effect on pH. RO reject was adjusted to low pH (4, 5 and 6) to see whether antiscalant breakdown at acid or alkaline pH occurred. There was no desaturation observed at the membrane surface with the change of RO reject pH in the range of 4-6 standard units.

TABLE 6
Summary of Gypsum seeding based desaturation
Three separate experiments
Effect of repeated cycling
Effect of NaCl in desaturation tank
Effect of pH

| Effect of | | Effect of NaCl | | | |
|---|---|---|---|---|---|
| Repeated | | in desaturation | | | |
| Cycles | | tank | | Effect of pH | |
| Seeding Cycle | Ca (mg/l) | NaCl (%) | Ca (mg/l) | pH | Ca (mg/l) |
| 1 | 1191 | 3 | 1828 | 3 | 1221 |
| 2 | 1254 | 4 | 1894 | 4 | 1205 |
| 3 | 1281 | 5 | 1938 | 5 | 1235 |
| 4 | 1373 | | | | |
| 5 | 1482 | | | | |

Fe co-precipitation performs better when initial calcium levels are high whereas gypsum showed consistently same level of performance throughout the range (1800-4000 mg/l) studied.

### 3.3 Soda Softening

It was observed that many of the trace contaminants remained in the gypsum effluent if gypsum seeding was utilized for desaturation. To minimize the trace constituents from the system; two of the standard precipitation methods (Fe co-precipitation and soda softening) were examined to remove trace contaminants. For this purpose, gypsum effluent was treated with either Fe hydroxide co-precipitation or soda softening. One hundred ppm of Fe was used for co-precipitation was tested for Fe co-precipitation while molar ratio of soda ash (˜2.5 gpl) was employed based on soda softening.

The results are shown in Table 7. Though soda softening removed many of the trace components, molybdenum was not removed at this level (0.1 mg/l). On the other hand, Fe co-precipitation removed molybdenum to a high degree and partially removed other trace elements as well.

TABLE 7
Summary of trace element analysis after secondary precipitation

| Sample | Ca | Al | B | Ba | Cu | Fe | Mn | Mg | Mo | Ni | Sn | Zn |
|---|---|---|---|---|---|---|---|---|---|---|---|---|
| RO Reject | 2903 | 1.34 | 0.372 | 0.194. | 1.25 | 0.478 | 0.105 | 54.61 | 0.089 | 0.083 | 0.081 | 0454 |
| Clarifier | 1170 | 1.39 | 0.393 | 0.196 | 1.14 | 0.503 | 0.117 | 53.09 | 0.096 | 0.085 | 0.088 | 0.432 |
| Effluent- | | | | | | | | | | | | |
| Gypsum | | | | | | | | | | | | |
| seeding | | | | | | | | | | | | |
| Seeding | 200 | 1.1 | 0.38 | 0.11 | 0.19 | 0.02 | 0.001 | 4.5 | 0.1 | 0.04 | 0.02 | 0.001 |
| followed by | | | | | | | | | | | | |
| soda | | | | | | | | | | | | |
| softening | | | | | | | | | | | | |
| Seeding | 1150 | 0.57 | 0.38 | 0.11 | 0.51 | 0.7 | 0.11 | 5.1 | 0.02 | 0.09 | 0.02 | 0.05 |
| followed by | | | | | | | | | | | | |
| Fe co- | | | | | | | | | | | | |
| precipitation | | | | | | | | | | | | |

* Concentrations are in mg/l

### 3.4 Effect of Fe Dosing on Gypsum Desaturation

In previous lab experiments, the Fe dosage was varied only at higher concentrations (100-400 mg/l). In order to minimize chemical use and reduce cost, low level Fe dosage was examined on gypsum desaturation. Three different types of RO rejects were tested with different amounts of Fe dosing (10-100 mg/l). The results of calcium and sulfate after desaturation are presented in Table 8. The results showed that desaturation could be effective even with 10 mg/l of Fe dosing. Similar to previous experiments, desaturation by Fe dosing was effective only high initial calcium concentration (reject of 65% recovery) compared to other two RO rejects. Similarly, the trace elements were analyzed and found that Molybdenum was completely removed even by 10 mg Fe dosing. These results suggest that low Fe dosing can be considered to reduce the operating cost. The trace elements are presented in following section along with gypsum seeding based desaturation results.

TABLE 8
Summary of desaturation of experiments using
different Fe dosage Concentrations in mg/l

| | | | | | | |
|---|---|---|---|---|---|---|
| % Recovery | 55 | 55 | 60 | 60 | 65 | 65 |
| Reject conc. | 2729 | 4600 | 2069 | 5200 | 3609 | 5800 |

Clarified Water mg/l

| Fe Dosage | Ca | SO4 | Ca | SO4 | Ca | SO4 |
|---|---|---|---|---|---|---|
| 10 | 1924 | 3200 | 1561 | 2900 | 1416 | 3400 |
| 25 | 2086 | 3600 | 1630 | 2900 | 1286 | 3200 |
| 50 | 2010 | 3400 | 1664 | 3000 | 1340 | 2900 |
| 75 | 2229 | 3900 | 1665 | 3000 | 1442 | 3500 |
| 100 | 2129 | 3600 | 1667 | 3000 | 1629 | 3600 |

### Fe Dosage

### 3.5 Gypsum Seeding and Low Fe Dosage

Previous experiments on gypsum desaturation using gypsum seeding revealed that the trace elements were not removed under this condition. Therefore, a combination of gypsum seeding and low Fe dosage was investigated. In these experiments, RO reject (200 ml) was initially seeded with 5 g fresh gypsum crystals and then 10 mg/l of Fe was added to the mixture. The pH was mixture was adjusted to 4.5-5.0 and stirred for 15 minimum. After settling, the gypsum was reused for seeding next set of desaturation experiment but fresh Fe solution (10 mg/l) was used for each cycle. The results of calcium and sulfate after desaturation are given in Table 9. The desaturation has been consistently effective up to 5 cycles with multiple of use of used gypsum.

TABLE 9
Summary of gypsum desaturation using gypsum
seeding and low Fe dosing

| Fe Dosage | Ca | SO4 | Ca | SO4 |
|---|---|---|---|---|
| % Recovery | 60 | 60 | 65 | 65 |
| Reject | 2729 | 4600 | 3603 | 5800 |
| conc. | | | | |

Clarified Water mg/l

| | | | | |
|---|---|---|---|---|
| Cycle 1 | 1520 | 2500 | 1295 | 2400 |
| Cycle 2 | 1483 | 2600 | 1449 | 2800 |
| Cycle 3 | 1476 | 2400 | 1311 | 2600 |
| Cycle 4 | | | 1263 | 2600 |
| Cycle 5 | | | 1334 | 2600 |

The summary of trace metal and TOC results from both experiments are presented in Table 10. In both cases, Molybdenum was removed along with few other selected trace elements. TOC was reduced by 50% after desaturation. To confirm this solid was also analyzed for TOC which showed ˜450 g/g and could be accounted for 40% of retention. These results suggested that gypsum seeding in conjunction with 10-25 mg/l of Fe dosing could be a viable gypsum desaturation process.

TABLE 10
Trace elements profile of gypsum desaturation using different Fe dosing
and multiple of cycles of gypsum seeding (All concentrations are in mg/l)

| | TOC | Al | B | Cu | Fe | K | Mg | Mo | Na | Ni | Sn | Zn |
|---|---|---|---|---|---|---|---|---|---|---|---|---|
| Fe co- | | | | | | | | | | | | |
| precip | | | | | | | | | | | | |
| 10 | 5.6 | 0.080 | 0.447 | 0.687 | 0.937 | 213 | 122 | 0.042 | 5999 | 0.226 | ND | 0.107 |
| 25 | 4.7 | 0.081 | 0.442 | 1.460 | 0.672 | 213 | 122 | 0.001 | 5996 | 0.201 | 0.001 | 0.095 |
| 50 | 4.2 | 0.050 | 0.442 | 0.656 | 0.169 | 211 | 122 | 0.001 | 5986 | 0.193 | ND | 0.091 |
| 75 | 4.2 | 0.050 | 0.403 | 0.030 | ND | 213 | 122 | 0.006 | 6083 | 0.144 | ND | 0.027 |
| 100 | 3.8 | 0.108 | 0.357 | 0.583 | 0.925 | 157 | 99 | 0.001 | 4630 | 0.175 | ND | 0.076 |
| Gypsum | | | | | | | | | | | | |
| seeding | | | | | | | | | | | | |
| Reject | 9.4 | 0.209 | 0.416 | 1.44 | 0.166 | 216.2 | 121.3 | 0.062 | 6002 | 0.199 | 0.004 | 0.091 |
| Cycle 1 | 5.1 | 0.102 | 0.381 | 0.607 | 0.612 | 166 | 103 | 0.005 | 4736 | 0.198 | ND | 0.072 |
| Cycle 2 | 6 | 0.050 | 0.419 | 0.030 | ND | 211 | 120 | 0.037 | 5883 | 0.073 | 0.001 | ND |
| Cycle 3 | 4.1 | 0.130 | 0.442 | 1.12 | 0.401 | 214 | 120 | 0.005 | 5766 | 0.266 | ND | 0.152 |
| Cycle 4 | 3.1 | 0.108 | 0.482 | 1.55 | 1.523 | 203 | 115 | 0.006 | 5583 | 0.240 | ND | 0.122 |
| Cycle 5 | 4 | 1.110 | 0.479 | 1.43 | 1.280 | 206 | 118 | 0.004 | 5607 | 0.250 | ND | 0.129 |

### 4. Pilot Operation

### 1.1 Pilot Process Description

FIG. 2 depicts schematic diagram of the process flow process employed in our study. RO feed was the mixture of fresh feed (1) and return line from the clarifier which was held in collection tank 10. The ratio between the fresh feed and return line was always in the range of 80:20. The blended RO feed was sent through 1 micron cartridge filter (5) before reaching the RO system. An external pump (not indicated) was used to feed RO. The reject stream was transferred into a continuous stir tank reactor (CSTR) (8) at which FeCl₃ solution was added (12) using a dosing pump and the pH of the mixture was adjusted to 4.5 using diluted NaOH (11) with the help of pH controller. In some experiments gypsum seeding was added to the CSTR to improve desaturation. The overflow from the clarifier was collected in a separate tank (10). The basic descriptions of equipment employed in this study are given below.

1) Fresh feed was prepared on daily basis @ 2000 liters batch (1). All chemicals were individually added in solution form to match real RO compositions. It was thoroughly mixed through recirculation using air diaphragm pump. The pH was feed was adjusted to 6.1+0.1.
2) RO feed tank(3) was 1000 liter capacity. The water level in the tank was maintained in the range of 450-500 liters during the operation. The tank was equipped with a mixer to mix fresh feed, return line and antiscalant(2) continuously.
3) 10 inch cartridge filter(5) of 1 micron pore size was used upfront to the RO system (6). Filter element was replaced when the pressure drop exceeds 2 bars.

4) SWRO (6) system used in this study was from AGEAN (model 1300, Skimoil Inc, St Louis Mo.), containing 1:1:1 multistage 2.5 inch sea water membranes with pressure rating of 1000 psig.

The system was designed for 0.9 us gpm product flow @ 25% recovery from seawater. The system did not have any recirculation facility and therefore, Feed valve and recirculation valve were added to the system to improve system recovery. The RO system was operated at 1.0-1.2 gpm product flow.

5) CSTR (8) was continuous stir tank reactor of 300 liters capacity which receives RO reject stream. FeCl₃ was added into this reactor with the help of dosing pump (@100 mg/l as Fe) and the pH of mixture was adjusted to 4.5 using NaOH and a pH controller. There is a mixer, stirring @ 100 rpm. The retention time of the CSTR is around 60 min. Though the reaction did not require such a long retention time, but a readily available tank was used for this study.

6) A cone bottom tank of 1000 liter capacity (9) used for gypsum settling. This tank receive the over flow from CSTR (8) and transfer the over flow to different tank after settling. The bottom drain line (14) was used to discharge sludge every day at the end of operation or a portion continuously recycled to reactor tank if utilizing Gypsum seeding.
7) The return line collection tank (10) was of 300 liter capacity. The solution was filtered through cartridge filter (4) before pumping into RO feed tank.
8) Solutions: Antiscalant: 2000 mg/l concentrated antiscalant solution was used in the process for dosing. The dosing rate was set to achieve 17 mg/l of antiscalant into the feed solution. FeCl3: 1.5% FeCl₃ solution was used for Fe dosing and 100 mg/l dosing was used throughout the process. NaOH: 2% solution was used for pH adjustment. It is critical that the antiscalant is prepared fresh on a daily basis.

### 1.2 Operation Protocol

RO pump and RO system were started after ensuring required water level (450-550 L) in the RO feed tank. Feed valve and recirculation valve were slowly adjusted to set the recovery around 55-65%. Subsequently, dosing pumps for antiscalant, FeCl₃ and NaOH were started to keep the complete process running. All initial operation was done using 17 mg/l antiscalant dosage. The permeate flow, reject flow and inlet pressure were monitoring on hourly basis. The pressure drop at the cartridge filter was monitored and replaced the filter when pressure exceeds 2 bars. The system was flushed with fresh water for 15 min everyday at the end of the operation. The process was run @ 55% recovery for four days and then @ 65% for five days. Gypsum seeding, in combination with low dosage of Fe (20 mg/l) was tested for four days. Finally, the antiscalant dosage was examined at two other concentration levels (5 & 10 mg/l).

### 1.3 Sampling Protocol

Samples from RO feed, Reject line, Clarifier and permeate were drawn every two hours. The pH, conductivity, temperature were immediately measured in all these samples and sent to laboratory for other chemical analysis. All of these samples were analyzed for Ca, SO₄, TOC and trace metals as well.

### 1.4 Process Performance

4.4.1 55% Recovery (Antiscalant Dosage 17 mg/l)

RO performance flow based recovery was about 55% (low: 51% and High 58%). The RO normalized data showed 20% decline on the fourth compared to the first day performance. The salt rejection was about 92-94% under these conditions. The recovery based on average conductivity of day to day operation was about 52%. A gradual increase of inlet pressure was observed within these four days operation (start 625 psig; end 700 psig).

### 4.4.1.1 Process Chemistry

The calculated recovery based calcium and sulfate in feed and reject were in the range of 50-55% which is in good agreement with conductivity and flow based results. The average concentration of calcium and sulfate in the reject stream was 2829 mg/l (Ca) and 5171 mg/l (SO₄) from which there were reduced to 1613 mg/l (Ca) and 2908 mg/l (SO₄) in the clarifier after desaturation. The TOC in reject line and clarifier showed that some of the TOC were being retained in the sludge which indicates that TOC will not build up in the loop during long term operation. These TOC data was using 17 mg/l antiscalant dosage.

### 4.4.1.2 Trace Elements Profile

The trace elements profile at four stages (feed, reject, clarifier and permeate) are given in Table 4.1. As it can be seen, Molybdenum was completely removed after desaturation. Similarly few selected trace metals were also reduced through co precipitation. However, Mg and B were not removed during desaturation which means there would be an increase steadily within the loop.

TABLE 4.1
Trace elements profile of 55% RO recovery operation

| Sample/day | Al | B | Cu | Fe | K | Mn | Mg | Mo | Na | Ni | Sn | Zn |
|---|---|---|---|---|---|---|---|---|---|---|---|---|
| Feed/1 | 0.084 | 0.415 | 0.362 | 0.071 | 60.16 | 0.089 | 37.85 | 0.023 | 2030 | 0.064 | 0.012 | 0.048 |
| Feed/2 | 0.166 | 0.382 | 0.531 | 0.113 | 65.41 | 0.137 | 38.23 | 0.022 | 2091 | 0.089 | 0.032 | 0.107 |
| Feed/3 | 0.153 | 0.295 | 0.567 | 0.117 | 68.23 | 0.108 | 38.06 | 0.024 | 1844 | 0.110 | 0.028 | 0.094 |
| Feed/4 | 0.119 | 0.289 | 0.560 | 0.132 | 70.45 | 0.124 | 40.79 | 0.033 | 1865 | 0.108 | 0.016 | 0.095 |
| Reject/1 | 0.183 | 0.752 | 0.798 | 0.096 | 165.3 | 0.163 | 86.7 | 0.043 | 5043 | 0.109 | 0.013 | 0.082 |
| Reject/2 | 0.302 | 0.621 | 1.258 | 0.183 | 169.4 | 0.259 | 84.5 | 0.042 | 4987 | 0.154 | 0.021 | 0.150 |
| Reject/3 | 0.254 | 0.483 | 1.303 | 0.191 | 190.7 | 0.208 | 89.8 | 0.048 | 4810 | 0.199 | 0.027 | 0.122 |
| Reject/4 | 0.204 | 0.449 | 1.216 | 0.229 | 175.3 | 0.216 | 89.1 | 0.058 | 4416 | 0.178 | 0.022 | 0.120 |
| Clarifier | 0.205 | 0.736 | 0.828 | 0.157 | 164.9 | 0.203 | 88.0 | 0.001 | 5134 | 0.110 | 0.003 | 0.204 |
| Overflow/1 | | | | | | | | | | | | |
| Clarifier | 0.200 | 0.641 | 0.930 | 0.154 | 166 | 0.256 | 78.9 | 0.001 | 4892 | 0.146 | 0.006 | 0.269 |
| Overflow/2 | | | | | | | | | | | | |
| Clarifier | 0.292 | 0.552 | 1.140 | 0.182 | 193 | 0.245 | 83.8 | 0.001 | 4799 | 0.209 | 0.004 | 0.148 |
| Overflow/3 | | | | | | | | | | | | |
| Clarifier | 0.248 | 0.496 | 1.131 | 0.59 | 184 | 0.268 | 88.4 | 0.001 | 4612 | 0.185 | 0.003 | 0.153 |
| Overflow/4 | | | | | | | | | | | | |
| Permeate/1 | 0.001 | 0.146 | 0.010 | 0.001 | 7.325 | 0.009 | 1.110 | 0.002 | 159.8 | 0.003 | 0.003 | 0.008 |
| Permeate/2 | 0.007 | 0.162 | 0.008 | 0.001 | 6.013 | 0.005 | 0.0893 | 0.001 | 130.7 | 0.004 | 0.009 | 0.059 |
| Permeate/3 | 0.007 | 0.139 | 0.004 | 0.001 | 4.938 | 0.002 | 0.525 | 0.001 | 96.1 | 0.005 | 0.006 | 0.046 |
| Permeate/4 | 0.010 | 0.134 | 0.004 | 0.001 | 5.087 | 0.003 | 0.608 | 0.008 | 101.9 | 0.004 | 0.006 | 0.047 |

(All concentrations are in mg/l)

4.4.2 65% Recovery (Antiscalant Dosage 17 mg/l)

The RO flow based recovery was in the range of 60-70% with an average of 64% during five days operation. One data point on day 3 showed very high recovery. This was basically due to blockage at RO feed cartridge filter which caused reduction in reject flow. Flow was brought back to normal after replacing the filter. The RO inlet pressure was 700 psig on the first day and increased to 810 psig within three days and remains same for other days. The RO normalized data showed 20% decline over 6 days operation. The recoveries based on conductivity were also calculated to be in the range of 60-65%.

### 4.4.2.1 Process Chemistry

The calculated recovery based calcium concentration in feed and reject were in the range of 60-65% which were comparable the same calculated from conductivity and flow results. As mentioned before, the reject flow reduced substantially when the cartridge filter pressure drop exceeds 2 bar. Under this condition, the calcium concentration increased as high as 5039 mg/l on day 1 evening. However, these values dropped back to expected levels (3600 mg/l) after replacing with new filter element. While looking at sulfate results, lower recoveries (55-60%) were observed which could presumably due to the limitations on sulfate analysis at high concentration levels. The average concentration of calcium and sulfate in the reject stream was 3510 mg/l (Ca) and 5871 mg/l (SO₄) from which there were reduced to 1486 mg/l (Ca) and 2706 mg/l (SO₄) in the clarifier after desaturation. Fe dosage was halted due to plugging of feed line for a while on day 4 which caused high residual calcium concentration (2600 mg/l) but dropped back to normal (Ca-1500 mg/l) level after restarting Fe dosing. In summary, gypsum desaturation occurred effectively by Fe dosing and calculated to be 57% based on the average calcium concentration at reject stream and clarifier.

The TOC concentrations in the reject were in the range 6.54-8.04 mg/l with an average of 7.08 mg/l. Similarly, the clarifier was in the range of 2.42-3.71 mg/l with an average of 3.10 mg/l. The TOC in permeate was in the range of 0.20-0.54 mg/l with an average of 0.30 mg/l. Permeate TOC is not understood at this time however it may be due to a small leakage in the brine seal of the RO. At least 40-50% TOC concentration was removed during desaturation. This confirms that partial mixing of return line to the fresh feed would not cause any major increase in the TOC levels since the TOC in the clarifier was more closer to the feed concentration levels.

The trace element profile of RO feed, Reject, Clarifier and permeate are presented in Table 2. In general, it could be observed that concentration levels of various trace components at each stage were comparable within acceptable variation for six days of operation. These results were similar to the results of 55% recovery. In particular molybdenum was removed effectively through Fe co-precipitation.

TABLE 4.2
Trace elements profile of 65% RO recovery operation

| Sample/day | Al | B | Ba | Cu | Fe | K | Mn | Mg | Mo | Na | Ni | Sn | Zn |
|---|---|---|---|---|---|---|---|---|---|---|---|---|---|
| Feed/1 | 0.06 | 0.20 | 0.12 | 0.52 | 0.13 | 64.9 | 0.10 | 43.0 | 0.02 | 1909 | 0.09 | 0.00 | 0.04 |
| Feed/2 | 0.07 | 0.23 | 0.22 | 0.50 | 0.13 | 55.1 | 0.12 | 43 | 0.03 | 2031 | 0.10 | 0.01 | 0.07 |
| Feed/3 | 0.07 | 0.26 | 0.22 | 0.46 | 0.10 | 64.5 | 0.12 | 40 | 0.03 | 1785 | 0.10 | 0.01 | 0.07 |
| Feed/4 | 0.04 | 0.29 | 0.28 | 0.43 | 0.11 | 61.8 | 0.10 | 35.8 | 0.02 | 1650 | 0.09 | 0.00 | 0.11 |
| Feed/5 | 0.05 | 0.31 | 0.28 | 0.40 | 0.15 | 65.4 | 0.11 | 37.9 | 0.10 | 1733 | 0.10 | 0.01 | 0.11 |
| Feed/6 | 0.04 | 0.34 | 0.27 | 0.38 | 0.10 | 64 | 0.12 | 34.9 | 0.03 | 1684 | 0.11 | 0.00 | 0.12 |
| Reject/1 | 0.35 | 0.38 | 0.31 | 2.01 | 0.43 | 263 | 0.24 | 142 | 0.05 | 7107 | 0.15 | 0.01 | 0.08 |
| Reject/2 | 0.26 | 0.41 | 0.37 | 1.56 | 0.25 | 190 | 0.24 | 120 | 0.05 | 5812 | 0.20 | 0.02 | 0.11 |
| Reject/3 | 0.13 | 0.45 | 0.34 | 1.24 | 0.19 | 191 | 0.23 | 100 | 0.05 | 4961 | 0.19 | 0.01 | 0.10 |
| Reject/4 | 0.15 | 0.59 | 0.45 | 1.09 | 0.33 | 221 | 0.29 | 107 | 0.07 | 5461 | 0.24 | 0.01 | 0.18 |
| Reject/5 | 0.11 | 0.54 | 0.40 | 1.10 | 0.31 | 208 | 0.25 | 101 | 0.05 | 5112 | 0.21 | 0.01 | 0.14 |
| Reject/6 | 0.07 | 0.57 | 0.39 | 1.09 | 0.21 | 209 | 0.25 | 97.8 | 0.05 | 5144 | 0.21 | 0.01 | 0.14 |
| Clarifier | 0.17 | 0.37 | 0.18 | 1.14 | 0.41 | 179 | 0.25 | 99.4 | 0.01 | 5008 | 0.17 | 0.01 | 0.09 |
| Overflow/1 | | | | | | | | | | | | | |
| Clarifier | 0.24 | 0.39 | 0.26 | 1.20 | 0.28 | 155 | 0.28 | 105.1 | 0.00 | 4933 | 0.18 | 0.02 | 0.12 |
| Overflow/2 | | | | | | | | | | | | | |
| Clarifier | 0.17 | 0.41 | 0.27 | 1.20 | 0.19 | 185 | 0.29 | 107.7 | 0.01 | 5084 | 0.20 | 0.01 | 0.15 |
| Overflow/3 | | | | | | | | | | | | | |
| Clarifier | 0.13 | 0.45 | 0.32 | 0.87 | 0.63 | 178 | 0.28 | 101.5 | 0.00 | 4867 | 0.20 | 0.01 | 0.15 |
| Overflow/4 | | | | | | | | | | | | | |
| Clarifier | 0.122 | 0.51 | 0.34 | 0.85 | 0.33 | 185 | 0.29 | 100.7 | 0.00 | 4877 | 0.21 | 0.00 | 0.19 |
| Overflow/5 | | | | | | | | | | | | | |
| Clarified | 0.14 | 0.57 | 0.32 | 0.91 | 0.08 | 193 | 0.30 | 101.2 | 0.01 | 4984 | 0.22 | 0.01 | 0.19 |
| Overflow/6 | | | | | | | | | | | | | |
| Permeate/1 | 0.01 | 0.09 | 0.00 | 0.01 | 0.02 | 8.43 | 0.01 | 1.16 | 0.00 | 180.6 | 0.00 | 0.00 | 0.00 |
| Permeate/2 | 0.01 | 0.13 | 0.31 | 0.00 | 0.02 | 6.30 | 0.00 | 0.99 | 0.00 | 149.5 | 0.01 | 0.00 | 0.05 |
| Permeate/3 | 0.01 | 0.17 | 0.23 | 0.01 | 0.01 | 6.37 | 0.00 | 0.92 | 0.00 | 125.5 | 0.01 | 0.00 | 0.04 |
| Permeate/4 | 0.01 | 0.17 | 0.39 | 0.02 | 0.01 | 11.14 | 0.01 | 1.80 | 0.00 | 221.2 | 0.01 | 0.00 | 0.04 |
| Permeate/5 | 0.01 | 0.23 | 0.34 | 0.01 | 0.02 | 11.43 | 0.01 | 1.48 | 0.00 | 220.9 | 0.01 | 0.01 | 0.06 |
| Permeate/6 | 0.01 | 0.20 | 0.35 | 0.00 | 0.01 | 8.86 | 0.00 | 1.07 | 0.00 | 171.97 | 0.01 | 0.00 | 0.07 |

(All concentrations are in mg/l)

### 4.4.3 Desaturation Using Gypsum Seeding & Fe Dosing (20 Mg/L)

In laboratory experiments, the gypsum desaturation utilizing gypsum seeding showed good desaturation performance. The same has also been examined in pilot study. The gypsum settled in the clarifier was re-circulated back to the CSTR utilizing an air diaphragm pump to obtain a dosage of 25-50 gpl. A small amount of Fe (20 mg/l) was also added to the reactor in order to remove other trace contaminants including Molybdenum. The pilot process was run under this condition for three days, setting the RO recovery at 62-65%. The RO performance was equivalent to the previous week with an average flow based recovery of 65.6% (range 63-67%). No Significant flux decline was observed within three days operation (range 4.6-5.0 Ipm, permeate). Conductivity, calcium and sulfate results were statistically analyzed to evaluate the desaturation performance.

The calcium concentrations in the reject were in the range of 2920-3176 mg/l (Avg) 3048 mg/l). Feed concentrations were in the range of 1006-1179 mg/l (Avg. 1090 mg/l). Based on these results, the calculated RO recovery was about 64% which is close to the flow based recovery. The calcium concentrations in the clarifier were in the range of 1350-1563 mg/l (Avg. 1426 mg/l). The desaturation was calculated to be 53% from calcium levels in reject and clarifier based upon calcium levels. Similar statistical analyses were made for sulfate results which showed 10% less than calcium based results. The same kind of trend was observed in all operating conditions [Fe dosing (55%, 65%) and gypsum seeding (65%)] which was mainly due to analytical limitations of sulfate analysis (HACH) as explained before. The average concentration of several trace elements for the gypsum seeding desaturation process is given in Table 3. The trace element concentration levels were similar to Fe alone treatment method and in particular molybdenum has been effectively removed even with 20 mg/l Fe dosing. The TOC results of three days operation showed that Feed TOC was around 2.5 mg and in the reject was in the range of 5-7 mg/l and reduced to 2.5 mg/l after desaturation (Clarifier). In summary, it can be said that gypsum seeding and a small amount Fe dosage (20 mg/l) can be used for gypsum desaturation, trace elements removal and TOC reduction.

TABLE 4.3
Summary of trace elements profile of gypsum seeding desaturation process

| Sample | Al | B | Ba | Cu | Fe | K | Mn | Mg | Mo | Na | Ni | Sn | Zn |
|---|---|---|---|---|---|---|---|---|---|---|---|---|---|
| Feed | 0.05 | 0.34 | 0.23 | 0.38 | 0.10 | 57.74 | 0.12 | 31.62 | 0.03 | 1445 | 0.11 | 0.01 | 0.11 |
| Reject | 0.08 | 0.56 | 0.33 | 0.84 | 0.18 | 172.55 | 0.23 | 76.71 | 0.05 | 4330 | 0.21 | 0.02 | 0.14 |
| Clarifier | 0.06 | 0.55 | 0.26 | 0.60 | 0.05 | 183.95 | 0.25 | 81.66 | 0.02 | 4591 | 0.20 | 0.00 | 0.13 |
| Overflow | | | | | | | | | | | | | |
| Permeate | 0.01 | 0.25 | 0.27 | 0.08 | 0.01 | 12.0 | 0.05 | 1.80 | 0.01 | 248.8 | 0.04 | 0.00 | 0.06 |

(Average concentrations for three days data, concentrations are in mg/l)

Barium Analysis:

Barium analysis by using multi element test method caused matrix interference due to which a background barium concentration was always above 0.2 mg/l even though Feed concentration is only 0.03 mg/l. To determine the barium rejection, a composite sample of Feed, permeate, reject and clarifier effluent were separately analyzed using single element test method. The results are shown in Table 4.3.1 below. The permeate concentration was below detection limit. Clarifier effluent concentration was almost similar to Reject concentration which indicates Ba is not precipitated as BaSO₄ at this small concentration levels.

| Sample description | Ba (mg/l) |
|---|---|
| Feed | 0.031 |
| Permeate | <0.002 |
| Reject | 0.075 |
| Clarifier Effluent | 0.065 |

### 4.4.5 Effect of Antiscalant Dosage

All previous experiments were operated using 17 mg/l of antiscalant dosage. This dosing is on higher side since vendor antiscalant software projections were mostly in the range of 4-5 mg/l. Never the less, three different antiscalant dosages (5 mg/l, 10 mg/l and 17 mg/l) were tested to understand their influence in RO performance. In all three conditions, the inlet RO pressure was maintained in between 800-820 psig. Experimentation showed that the permeate flow decreased within 3 hours when 5 mg/l antiscalant was used. The recovery was reduced from 60% to 47% in 3 hours. For the second testing with 10 mg/l antiscalant, the RO performance was a little more stable but decreased with respect to time and reached 50% on third day operation. If we compare the RO performance at 17 mg/l; there was no significant decline for nine days operation (refer 65% recovery and gypsum seeding data). RO recovery was maintained within 60-65% constantly. The chemical analysis data showed similar performance. Calcium in reject was decreased from 2700 mg/l to 2200 mg/l within 3 hours when 5 mg/l antiscalant was used. A similar decrease was observed for 10 mg/l dosage on the third day operation. But, calcium concentration was always 3000-3500 mg/l when 17 mg/l antiscalant was used. These results suggest that a higher antiscalant dosage (17 mg/l) may generally be required to sustain RO performance.

### 5.0 Summary

The Pilot study results demonstrated that this process can be an effective process for the removal of sulfate from acid mine drainage. In particular, post RO treatment test results from lab as well as Pilot were promising for gypsum desaturation and co-precipitation of other trace contaminants including molybdenum.

Our studies under different conditions showed that 17 mg/l could be an optimum antiscalant dosage to achieve 65% recovery which remained same for 9 days operation. If 55-65% of RO recovery is obtained, the overall recovery with recycle could be in the range of 77-82%. Specific points are separately presented below for both laboratory and pilot.

### 5.1 From Laboratory Experiments

1. Fe hydroxide precipitation effectively desaturates gypsum up to 70% and removed other trace contaminants including molybdenum. The optimum dosage was about 100 mg Fe/l. However, it was observed that desaturation was reduced when initial calcium concentration was low (2000 mg/l). The pH has also showed small negative impact in desaturation especially when initial calcium levels are high (4000 mg/l).
2. Aluminum was another reagent which could be considered for gypsum desaturation. However, there was residual aluminum after desaturation which might cause gradual build-up of Al concentration within the loop and can affect RO performance on long term operation.
3. Gypsum seeding showed an effective desaturation (up to 70%) even at 25-50 gpl seeding. However many of the trace contaminants were still in the effluent which may need an additional treatment to remove them. The effect of pH and NaCl studies showed that it could work in any pH range but NaCl decreased desaturation efficiency (40-50% from 70%). Gypsum seeding was effective through the range of calcium concentration studied (2000-4000 mg/l).
4. The study on Fe dosage showed that even small amount of Fe (10 mg/l) would be enough to accelerate gypsum desaturation and to co-precipitate molybdenum.
5. The use of spent gypsum generated from desaturation could be used for seeding purpose and the results were consistent up to five cycles. Gypsum seeding in conjunction with 10 mg/l of Fe dosing resulted in better desaturation (10-20%) than ‘Fe’ alone dosing experiments.
6. Gypsum desaturation in conjunction with Fe co-precipitation could be a viable process to treat the RO reject.

### 5.2 From Pilot Study

1. Gypsum desaturation using Fe dosing (100 mg/l) showed satisfactory performance in reducing Calcium levels to 1400-1600 mg/l from 2700-3500 mg/l levels.
2. Gypsum seeding in conjunction with 10 mg/l of Fe dosing was also effective in desaturation and removal of Molybdenum. The residual calcium was 1300 mg/l or less in this case compared to Fe dosing results.
3. At least 40-50% of TOC was removed during desaturation based on the TOC data of reject line and clarifier. The sludge was also analyzed to confirm the TOC retention in the sludge. TOC concentration was about 450-500 mg/Kg in the sludge.
4. RO system was operated at two different conditions (55% and 65%) and observed 10-20% flux decline with one week operation based RO normalized data.
5. The effect of antiscalant dosage was separately examined and results indicated that 17 mg/l must be considered for better RO performance. Lower dosage such as 5 or 10 mg/l caused flux decline in very short time.

The combination of gypsum and ferric chloride addition to the desaturation process gives an improved effectiveness over single additive processing. The enhanced effectiveness of the combination of gypsum and ferric chloride addition to the desaturation process is shown from the following;

Table 6 shows that when using gypsum only in a multicycle mode, the calcium removal decreases with increasing cycle number, e.g., increased calcium in the recycled clarified water. However, as seen in Table 9, the combination gives a reduction in calcium concentration in the clarified water.

Furthermore, in Table 7 it can be seen that ferric chloride addition after gypsum desaturation further decreases Mo concentration in the clarified water, as is also seen in Table 10, where ferric chloride desaturation produces lower Mo concentrations in the clarified water than cyclic gypsum desaturation.

These results are confirmed in the results shown in Table 4.1 of the pilot testing, where the Mo concentration is exceeding low (0.001 mg/l) for desaturation using the combination of gypsum and ferric chloride.

What is claimed is:

1. A high recovery process for sulfate removal from a water source comprising the steps of;
providing a pretreated sulfate containing water input containing soluble and slightly soluble inorganic compounds and organic matter;
blending said input water in a blending volume with clarified recycle water from a co-precipitated reverse osmosis reject stream to produce a blended input water,
conditioning said blended water with antiscalant;
introducing said conditioned blended water into the high pressure side of a RO membrane system;
pressurizing said conditioned blended feed stream on said high pressure side of said RO membrane system to produce purified water permeate on the low pressure side of said RO membrane system substantially free of inorganic compounds;
removing a reject stream containing concentrated inorganic compounds from the high pressure side of the RO system;
subjecting the reject stream to a co-precipitating process capable of removing a sufficient portion of the inorganic compounds so as to produce a clarified recycle water stream suitable for blending with the pretreated water input and a concentrated solids—water slurry;
removing said slurry to drain or by other suitable waste disposal means; and
recycling said clarified water stream to said blending volume.

2. The process of claim 1 wherein the input water is blended with the clarified recycle water in a ratio of from about 7 to 3 to a ratio of about 9 to 1.

3. The process of claim 1 wherein the co-precipitation process comprises flowing the reject stream into a CSTR, adding at least one co-precipitating agent, and after a suitable reaction time in the CSTR, flowing the reacted reject stream to a settling tank where the precipitated ion compounds are separated, collected and removed and clarified water is recycled to the blending volume.

4. The process of claim 3 wherein the at least one co-precipitating agent is chosen from the group consisting of ferric chloride, ferrous chloride, and ferric sulfate.

5. The process of claim 3 wherein the at least one co-precipitating agent is ferric chloride.

6. The process of claim 5 wherein ferric chloride is added to the CSTR to attain a concentration of from about 10 mg/L to about 400 mg/liter.

7. The process of claim 5 wherein ferric chloride is added to the CSTR to attain a concentration of from about 10 mg/L to about 100 mg/liter.

8. The process of claim 5 wherein ferric chloride is added to the CSTR to attain a concentration of from about 10 mg/L to about 25 mg/liter.

9. The process of claim 3 wherein gypsum seed particles are used as co-precipitating agent.

10. The process of claim 9 wherein gypsum seed particles are added at a rate of about approximately 5 grams to about approximately 50 grams per liter of liquid in the CSTR.

11. The process of claim 9 wherein gypsum seed particles are obtained from the slurry of the settling tank.

12. The process of claim 9 wherein gypsum seed particles are reused from about approximately 3 to approximately 6 times.

13. The process of claim 3 wherein gypsum seed particles and ferric chloride are used as co-precipitating agents.

14. The process of claim 13 wherein ferric chloride is added to the CSTR to attain a concentration of from about 10 mg/L to about 400 mg/liter.

15. The process of claim 13 wherein ferric chloride is added to the CSTR to attain a concentration of from about 10 mg/L to about 100 mg/liter.

16. The process of claim 13 wherein ferric chloride is added to the CSTR to attain a concentration of from about 10 mg/L to about 25 mg/liter.

17. The process of claim 13 wherein gypsum seed particles are added at a rate of about approximately 5 grams to about approximately 50 grams per liter of liquid in the CSTR.

18. The process of claim 13 wherein gypsum seed particles are obtained from the slurry of the settling tank.

19. The process of claim 13 wherein gypsum seed particles are recycled from about approximately 3 to approximately 5 times.

20. The process of claim 1 wherein molybdenum in the reject stream is reduced to about 0.001 mg/l in the recycle water stream.

21. A high recovery process for sulfate and TOC removal from a water source comprising the steps of:
providing a pretreated sulfate containing water input containing soluble and slightly soluble inorganic compounds and TOC;
blending said input water in a blending volume with clarified recycle water from a co-precipitated reverse osmosis reject stream to produce a blended input water;
conditioning said blended water with antiscalant;
introducing said conditioned blended water into the high pressure side of a RO membrane system;
pressurizing said conditioned blended feed stream on said high pressure side of said RO membrane system to produce purified water permeate on the low pressure side of said RO membrane system substantially free of inorganic compounds and TOC;
removing a reject stream containing concentrated inorganic compounds and concentrated TOC from the high pressure side of the RO system;
subjecting the reject stream to a co-precipitating process capable of removing a sufficient portion of the inorganic compounds and TOC so as to produce a clarified recycle water stream suitable for blending with the pretreated water input and a concentrated solids—water slurry;
removing the slurry to drain or by other suitable waste disposal means; and
flowing said clarified recycle stream to said blending volume.

22. The process in claim 21 wherein the input water is blended with the clarified recycle water in a ratio of from about 7 to 3 to a ratio of about 9 to 1.

23. The process of claim 21 wherein the co-precipitation process comprises flowing the reject stream into a CSTR, adding at least one co-precipitating agent, and after a suitable reaction time in the CSTR, flowing the reacted reject stream to a settling tank where the precipitated ion compounds are separated, collected and removed and clarified water is recycled to the blending volume.

24. The process of claim 23 wherein the at least one co-precipitating agent is chosen from the group consisting of ferric chloride, ferrous chloride, and ferric sulfate.

25. The process of claim 23 wherein the at least one co-precipitating agent is ferric chloride.

26. The process of claim 25 wherein ferric chloride is added to the CSTR to attain a concentration of from about 10 mg/L to about 400 mg/liter.

27. The process of claim 25 wherein ferric chloride is added to the CSTR to attain a concentration of from about 10 mg/L to about 100 mg/liter.

28. The process of claim 25 wherein ferric chloride is added to the CSTR to attain a concentration of from about 10 mg/L to about 25 mg/liter.

29. The process of claim 23 wherein gypsum seed particles are used as co-precipitating agent.

30. The process of claim 29 wherein gypsum seed particles are added at a rate of about approximately 5 grams to about approximately 50 grams per liter of liquid in the CSTR.

31. The process of claim 29 wherein gypsum seed particles are obtained from the slurry of the settling tank.

32. The process of claim 29 wherein gypsum seed particles are reused from about approximately 3 to approximately 6 times.

33. The process of claim 23 wherein gypsum seed particles and ferric chloride are used as co-precipitating agents.

34. The process of claim 33 wherein ferric chloride is added to the CSTR to attain a concentration of from about 10 mg/L to about 400 mg/liter.

35. The process of claim 33 wherein ferric chloride is added to the CSTR to attain a concentration of from about 10 mg/L to about 100 mg/liter.

36. The process of claim 33 wherein ferric chloride is added to the CSTR to attain a concentration of from about 10 mg/L to about 25 mg/liter.

37. The process of claim 33 wherein gypsum seed particles are added at a rate of about approximately 5 grams to about approximately 50 grams per liter of liquid in the CSTR.

38. The process of claim 33 wherein gypsum seed particles are obtained from the slurry of the settling tank.

39. The process of claim 33 wherein gypsum seed particles are recycled from about approximately 3 to approximately 6 times.

40. The process of claim 23 wherein the clarified recycle water contains about approximately 40% to about approximately 60% of TOC of the reject stream entering the CSTR.

41. The process of claim 21 wherein molybdenum in the reject stream is reduced to about 0.001 mg/l in the recycle water stream.

42. The process of claim 1 wherein the RO membrane system comprises a reverse osmosis membrane module comprising one of seawater membranes, brackish water membranes or nanofiltration membranes.

43. The process of claim 21 wherein the RO membrane system comprises a reverse osmosis membrane module comprising one of seawater membranes, brackish water membranes or nanofiltration membranes.
